(19) United States
(12) Patent Application Publication
(10) Pub. No.: US 2017/0149378 A1
(43) Pub. Date: May 25, 2017

(54) SOLAR PANEL AND GROUNDING CONNECTORS

(71) Applicant: Hubbell Incorporated, Shelton, CT (US)

(72) Inventor: Kevin N. CASTONGUAY, Weare, NH (US)

(21) Appl. No.: 15/157,307

(22) Filed: May 17, 2016

Related U.S. Application Data
(60) Provisional application No. 62/258,234, filed on Nov. 20, 2015.

(51) Int. Cl. H02S 40/34; H01R 4/30

(52) U.S. Cl. CPC H02S 40/34; H01R 4/304

(57) ABSTRACT

A connector includes a body, a first slot formed in the body, the first slot dimensioned to receive an edge of a component, a second slot formed in the body, the second slot dimensioned to receive a conductor and a penetrating fastener for penetrating non-conductive coatings on a surface of the component and securing the component in the first slot.

### CROSS-REFERENCE TO RELATED APPLICATIONS

The present disclosure is based on and claims benefit from co-pending U.S. Provisional Application Ser. No. 62/258,234 filed Nov. 20, 2015 entitled “Solar Panel Connectors”, the entire contents of which are herein incorporated by reference.

### BACKGROUND

Field

The present disclosure relates generally to electrical connectors, and more particularly to electrical connectors for photovoltaic arrays and other electrical applications.

Description of the Related Art

Energy harnessed from the sun (e.g., solar energy) has many benefits. For example, solar energy is more environmentally friendly than fossil fuels and nuclear energy and can provide a seemingly endless supply of power. Solar panels utilize light energy from a light source (e.g., the sun) to generate electricity through the photovoltaic effect. A single solar panel is generally only capable of producing a limited amount of power. Accordingly, many installations contain several panels arranged in an array. The array of solar panels may be arranged in parallel, serial or both, depending on the energy requirements for the particular installation. In addition to the solar panels, a typical installation may also include one or more power inverters, batteries and interconnection wiring. Specially designed connection devices including clamping devices are used to connect solar panels, power inverters and batteries in an installation. Such devices must be capable of meeting certain code standards and capable of passing certain tests as required by those code standards.

Connection devices that use penetrating connectors such as screws, rivets, etc. to connect to the solar panel are not a viable option since they require holes to be drilled in the solar panel. Such holes may affect the integrity of components allowing moisture to enter and creating points where corrosion may become an issue. Accordingly, clamping type connectors have become the connector of choice for use with solar panel installations.

### SUMMARY

The present disclosure provides connectors used to facilitate grounding or bonding of electrical components, including components of photovoltaic arrays. In one exemplary configuration, the connector includes a body, a first slot formed in the body, a second slot formed in the body, and a penetrating fastener. The first slot is dimensioned to receive an edge of a component, the second slot is dimensioned to receive a conductor, and the penetrating fastener is used to penetrate a surface of the component to provide an electrically conductive path between the surface of the component and the connector, and to secure the component in the first slot.

In another exemplary configuration, the connector includes a body, a first set of arms extending from the body, a second set of arms extending from the body, and a penetrating fastener extending through one of the first set of arms. The first set of arms form a first slot dimensioned to receive an edge of a component, the second set of arms form a second slot dimensioned to receive a conductor, and the penetrating fastener is used to penetrate a surface of the component to provide an electrically conductive path between the surface of the component and the connector, and to secure the component in the first slot.

In another exemplary configuration, the connector includes a body made of an electrically conductive material, a first slot formed in the body, a second slot formed in the body and a penetrating fastener. The first slot is dimensioned to receive an edge of a component, and the second slot is dimensioned to receive a conductor. The penetrating fastener can secure the edge of the component in the first slot, and can penetrate non-conductive coatings on a surface of the component to provide an electrically conductive path between the component and the body.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective view of a connector according to an illustrative embodiment of the present disclosure secured to a component;

FIG. 2 is a perspective view of the connector of FIG. 1;

FIG. 3 is a cross-sectional view of the connector shown in FIG. 1, taken along the lines 3-3;

FIG. 4 is a perspective view of a connector according to another illustrative embodiment of the present disclosure;

FIG. 5 is a perspective view of a connector according to another illustrative embodiment of the present disclosure;

FIG. 6 is a perspective view of a connector according to another illustrative embodiment of the present disclosure;

FIG. 7 is a perspective view of a fastener having a cupped end according to an illustrative embodiment of the present disclosure; and

FIG. 8 is a perspective view of a fastener having a tapered cupped end according to an illustrative embodiment of the present disclosure.

### DETAILED DESCRIPTION

Illustrative embodiments of the present disclosure may be provided as improvements to electrical connectors for components in general electrical applications, such as components of photovoltaic arrays. Examples of components include components in general electrical applications include pools, lighting, raceways, conduits, etc. Examples of components of photovoltaic arrays include solar panels, rail systems supporting photovoltaic arrays, rack flanges, etc. For ease of description, such electrical components will be referred to in the plural as “components” and in the singular as “component.”

The connector according to an embodiment of the present disclosure facilitates an electrical conductive path between an electrical conductor secured to one portion of the connector and a component secured to another portion of the connector.

The connector according to the present disclosure may be mounted to a component without drilling and without additional mounting hardware. A connector according to an embodiment of the present disclosure includes a first set of arms dimensioned for receiving a component. The arms are capable of temporarily deflecting or flexing to allow for thermal expansion and contraction of the connector and/or component.

According to an embodiment of the present disclosure, a cup point fastener, e.g., a cupped point bolt, is used to secure the connector to a component. The cupped point tip provides a surface area of the fastener that can penetrate non-conductive coatings on the component. Examples of non-conductive coatings include oxide coatings, paints, anodized coatings, insulating coatings and powder coatings. The cupped point tip also reduces the area of the tip of the fastener in contact with the surface of the component which increases the holding and locking power of the fastener under pressure.

The connector according to an embodiment of the present disclosure includes a first opening for receiving a component, and a second opening offset from the first opening for receiving an electrical conductor or cable.

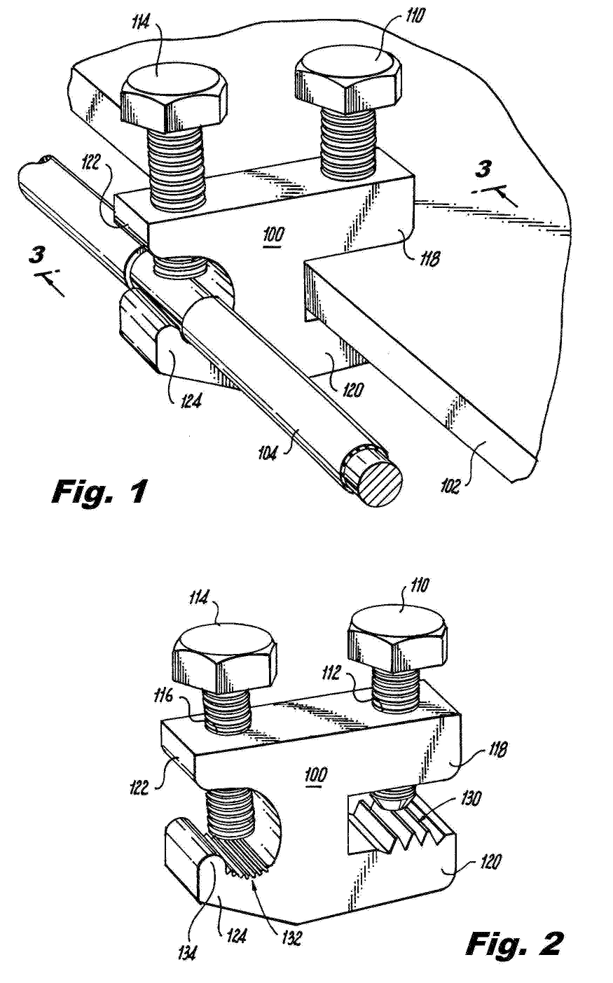

A connector according to an embodiment of the present disclosure is shown in FIGS. 1 and 2 and is referred to generally as connector 100. Connector 100 may be mounted to a component 102. An electrical conductor or cable 104 may be secured by connector 100 as shown.

Connector 100 may be formed from any suitable type of electrically conductive material including, for example, metals such as copper, alloys of copper, aluminum, alloys of aluminum, or bronze. According to an embodiment of the present disclosure, connector 100 has a one piece extruded aluminum body. Connector 100 has a first set of arms 118, 120 separated by a gap sufficient to receive a component 102. According to an embodiment of the present disclosure, lower arm 120 includes serrated surface 130 capable of piercing non-conductive coatings on the component 102. Connector 100 also includes a second set of arms 122, 124 separated by a gap sufficient to insert and hold electrical conductor 104. Lower arm 124 includes a lip 134 that helps cradle the conductor 104 and hold it in place. According to an embodiment of the present disclosure, lower arm 124 includes serrated surface 132 capable of piercing non-conductive coatings on the conductor 104. Serrated surfaces 130, 132 may be extruded serrations formed during the extrusion process or may be machined in the surface after extrusion of the connector 100. Arms 118 and 122 include threaded orifices 112 and 116 for receiving fasteners 110, 114, respectively. The fasteners 110, 114 may be any type of fastener capable of forming a portion of an electrically conductive path and securing a component and/or conductor to the connector 100. Examples of fasteners include threaded bolts and threaded set screws. Examples of threaded bolts include hex head bolts, allen head bolts, flange bolts, shoulder bolts and/or socket bolts. The fasteners may be made of a number of electrically conductive materials, including stainless steel, aluminum, bronze, steel, galvanized steel, and copper. In the embodiment shown in FIG. 2, the fasteners 110, 114 are hex-head bolts formed from stainless steel.

In order to provide a more positive electrically conductive path between a component 102 and a conductor 104, the fastener 110 has a penetrating tip that pierces non-conductive coatings on the outer surface of the component and contacts the metal portion of the component 102. According to an embodiment of the present disclosure, fastener 110 has a cupped point tip as shown in FIGS. 7 and 8. A depression 700 formed in the cupped point reduces the area of the tip of the fastener in contact with the component 102, which provides a surface that can penetrate non-conductive coatings on the component 102, and also increases the holding and locking power of the fastener under pressure. As noted above, other types of fasteners capable of penetrating non-conductive coatings on the component, capable of forming a portion of an electrically conductive path, and capable securing a component to the connector 100 may also be used.

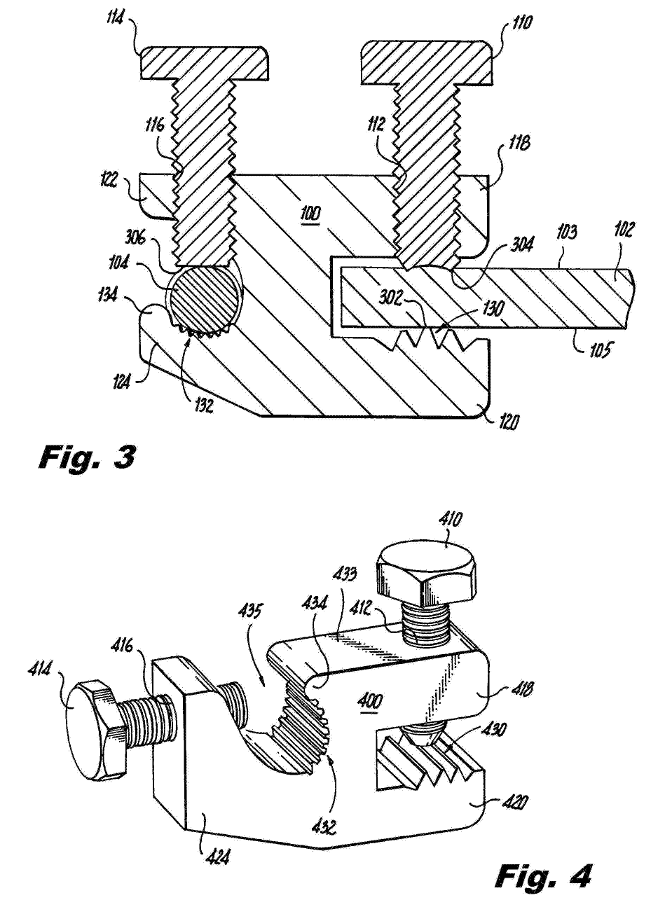

As shown in FIG. 3, fastener 110 has a cupped point 304 having outer edges formed by the depression 700, as seen in FIGS. 3, 7 and 8, that penetrate non-conductive coatings on and engages the upper surface 103 of a component 102. Fastener 110 can be tightened sufficiently such that points 302 of one or more serrations 130 penetrate non-conductive coatings on and engage the lower surface 105 of component 102. Fastener 114, e.g., a bolt, has a flat bottom surface 306 that engages the conductor 104. Fastener 114 can be tightened sufficiently such that the points of one or more serrations 132 penetrate non-conductive coatings, on the conductor 104.

According to an embodiment of the present disclosure, arms 118, 120 and 122, 124 are capable of temporarily deflecting to provide a compressive spring force on the fasteners 110, 114 when the fasteners 110, 114 are in contact with the component 102 and conductor 104. The deflection is temporary in that arms 118, 120 and 122, 124 return to their original positions when the compressive spring force on the fasteners 110, 114 is released by, for example, the fasteners 110, 114 being loosened. In addition, since the connectors are generally used outdoors, this temporary deflecting capability allows the connectors to go through repeated expansion and contraction caused by environmental heating and cooling cycles without the fasteners 110, 114 loosening.

A connector according to another embodiment of the present disclosure is depicted in FIG. 4 and is referred to generally as connector 400. Connector 400 has a first set of arms 418, 420 separated by a gap sufficient to receive a component. According to an embodiment of the present disclosure, lower arm 420 includes serrated surface 430 capable of piercing non-conductive coatings on the component. Connector 400 also includes a second arm 424 which together with the body of connector 400 forms a substantially U-shaped opening 435 along an upper surface 433 of the connector. The opening 435 is dimensioned to receive and hold a suitable conductor. The upper surface 433 may include a lip 434 that helps cradle the conductor and hold it in place. According to an embodiment of the present disclosure, an inside surface of connector 400 includes serrated surface 432 capable of piercing non-conductive coatings on the conductor. Serrated surfaces 430, 432 may be extruded serrations formed during the extrusion process or may be machined in the surface after extrusion of the connector 400. Arms 418 and 424 include threaded orifices 412 and 416 for receiving fasteners 410, 414, respectively. As shown in FIG. 4, opening 416 is substantially perpendicular to opening 412. The fasteners 410, 414 may be any type of fastener capable of forming a portion of an electrically conductive path and securing a component and/or conductor to the connector 400. Examples of fasteners include threaded bolts and threaded set screws. Examples of threaded bolts include hex head bolts, allen head bolts, flange bolts, shoulder bolts and/or socket bolts. The fasteners may be made of a number of electrically conductive materials, including stainless steel, aluminum, bronze, steel, galvanized steel, and copper. In the embodiment shown in FIG. 4, the fasteners 410, 414 are hex-head bolts formed from stainless steel.

In order to provide a more positive electrically conductive path between a component 102 and a conductor 104, fastener 410 has a penetrating tip that pierces non-conductive coatings on the outer surface of the component and contacts the metal portion of the component. According to an embodiment of the present disclosure, fastener 410 has a cupped point tip as shown in FIGS. 7 and 8. The depression 700 formed in the cupped point reduces the area of the tip of the fastener in contact with the surface of the component, which provides a surface that can penetrate non-conductive coatings on the component 102, and also increases the holding and locking power of the fastener under pressure. As noted above, other types of fasteners capable of penetrating non-conductive coatings on the component, capable of forming a portion of an electrically conductive path, and capable securing a component to the connector 400 may also be used.

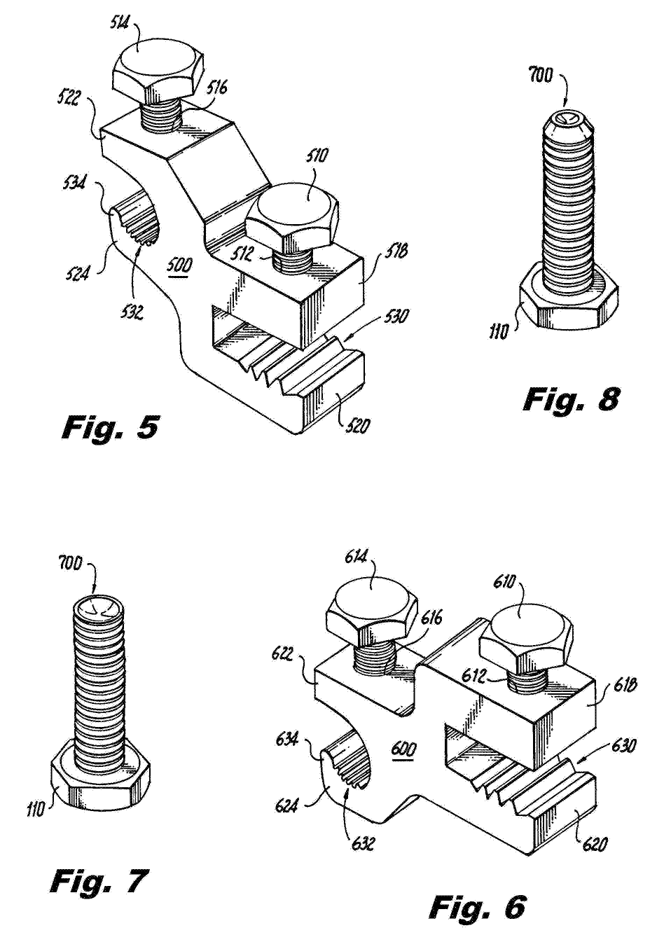

A connector according to another embodiment of the present disclosure is depicted in FIG. 5 and is referred to generally as connector 500. Connector 500 has a first set of arms 518, 520 separated by a gap sufficient to receive a component. According to an embodiment of the present disclosure, lower arm 520 includes serrated surface 530 capable of piercing non-conductive coatings on the component. Sometimes space between solar panels in photovoltaic arrays can be at a minimum. According to this embodiment of the present disclosure, connector 500 also includes a second set of arms 522, 524 separated by a gap sufficient to insert and hold a conductor. The second set of arms 522, 524 are offset from the first set of arms 512, 520. The offset of the second set of arms allows components to be placed closer together than would be possible without the offset. Lower arm 524 includes a lip 534 that helps cradle the conductor and hold it in place. According to an embodiment of the present disclosure, lower arm 524 includes serrated surface 532 capable of piercing non-conductive coatings on the conductor. Serrated surfaces 530, 532 may be extruded serrations formed during the extrusion process or may be machined in the surface after extrusion of the connector 500. Arms 518 and 524 include threaded orifices 512 and 516 for receiving fasteners 510, 514, respectively. The fasteners 510, 514 may be any type of fastener capable of forming a portion of an electrically conductive path and securing a component and/or conductor to the connector 500. Examples of fasteners include threaded bolts and threaded set screws. Examples of threaded bolts include hex head bolts, allen head bolts, flange bolts, shoulder bolts and/or socket bolts. The fasteners may be made of a number of electrically conductive materials, including stainless steel, aluminum, bronze, steel, galvanized steel, and copper. In the embodiment shown in FIG. 5, the fasteners 510, 414 are hex-head bolts formed from stainless steel.

In order to provide a more positive electrically conductive path between a component 102 and a conductor 104, fastener 510 has a penetrating tip that pierces non-conductive coatings on the outer surface of the component and contacts the metal portion of the component. According to an embodiment of the present disclosure, fastener 510 has a cupped point tip as shown in FIGS. 7 and 8. The depression 700 formed in the cupped point reduces the area of the tip of the fastener in contact with the surface of the component, which provides a surface that can penetrate non-conductive coatings on the component 102, and also increases the holding and locking power of the fastener under pressure. As noted above, other types of fasteners capable of penetrating non-conductive coatings on the component, capable of forming a portion of an electrically conductive path, and capable securing a component to the connector 500 may also be used.

A connector according to another embodiment of the present disclosure is depicted in FIG. 6 and is referred to generally as connector 600. Connector 600 has a first set of arms 618, 620 separated by a gap sufficient to receive a component. According to an embodiment of the present disclosure, lower arm 620 includes serrated surface 630 capable of piercing non-conductive coatings on the component. As described above with respect to FIG. 5, sometimes space between panels can be at a minimum. According to this embodiment of the present disclosure, connector 600 also includes a second set of arms 622, 624 separated by a gap sufficient to insert and hold a conductor. The second set of arms 622, 624 are offset from the first set of arms 612, 620. The offset of the second set of arms allows components to be placed closer together than would be possible without the offset. Lower arm 624 includes a lip 634 that helps cradle the conductor and hold it in place. According to an embodiment of the present disclosure, lower arm 624 includes serrated surface 632 capable of piercing non-conductive coatings on the conductor. Serrated surfaces 630, 632 may be extruded serrations formed during the extrusion process or may be machined in the surface after extrusion of the connector 600. Arms 618 and 624 include threaded orifices 612 and 616 for receiving fasteners 610, 614, respectively. The fasteners 610, 614 may be any type of fastener capable of forming a portion of an electrically conductive path and securing a component and/or conductor to the connector 600. Examples of fasteners include threaded bolts and threaded set screws. Examples of threaded bolts include hex head bolts, allen head bolts, flange bolts, shoulder bolts and/or socket bolts. The fasteners may be made of a number of electrically conductive materials, including stainless steel, aluminum, bronze, steel, galvanized steel, and copper. In the embodiment shown in FIG. 6, the fasteners 610, 614 are hex-head bolts formed from stainless steel.

In order to provide a more positive electrically conductive path between a component 102 and a conductor 104, fastener 610 has a penetrating tip that pierces non-conductive coatings on the outer surface of the component and contacts the metal portion of the component. According to an embodiment of the present disclosure, fastener 610 has a cupped point tip as shown in FIGS. 7 and 8. The depression 700 formed in the cupped point reduces the area of the tip of the fastener in contact with the surface of the component, which provides a surface that can penetrate non-conductive coatings on the component 102, and also increases the holding and locking power of the fastener under pressure. As noted above, other types of fasteners capable of penetrating non-conductive coatings on the component, capable of forming a portion of an electrically conductive path, and capable securing a component to the connector 600 may also be used.

While illustrative embodiments have been described and illustrated above, it should be understood that these are exemplary and are not to be considered as limiting. Additions, deletions, substitutions, and other modifications can be made without departing from the spirit or scope of the present invention. Accordingly, the invention is not to be considered as limited by the foregoing description.

What is claimed is:

1. A connector comprising:
a body;
a first slot formed in the body, the first slot dimensioned to receive an edge of a component;
a second slot formed in the body, the second slot dimensioned to receive a conductor; and
a penetrating fastener for penetrating a surface of the component and securing the component in the first slot.

2. The connector of claim 1, wherein the penetrating fastener comprises a cup point fastener.

3. The connector of claim 1, wherein the penetrating fastener comprises a cup point bolt.

4. The connector of claim 3, wherein the cup point bolt has a depression at an end forming an outer edge that contacts the surface of the component.

5. The connector of claim 4, wherein the outer edge of the depression penetrates non-conductive coatings on the surface of the component.

6. The connector of claim 4, wherein the depression reduces an area of the bolt in contact with the surface of the component which increases holding and locking power under pressure.

7. The connector of claim 1, further comprising a first pair of arms extending from the body and forming the first slot.

8. The connector of claim 7, wherein the penetrating fastener comprises a bolt that extends through one of the first pair of arms.

9. The connector of claim 7, wherein at least one of the arms extending from the body flexes providing a spring force that secures the penetrating fastener against the surface of the component.

10. The connector of claim 7, further comprising a serrated surface formed on at least one of the first pair of arms, the serrated surface abutting the surface of the component.

11. A connector comprising:
a body;
a first set of arms extending from the body, the first set of arms forming a first slot, the first slot dimensioned to receive an edge of a component;
a second set of arms extending from the body, the second set of arms forming a second slot dimensioned to receive a conductor; and
a penetrating fastener extending through one of the first set of arms for penetrating a non-conductive surface of the component and securing the component in the first slot.

12. The connector of claim 11, wherein the penetrating fastener comprises a cup point fastener.

13. The connector of claim 11, wherein the penetrating fastener comprises a bolt.

14. The connector of claim 13, wherein the bolt comprises a cup point bolt.

15. The connector of claim 14, wherein the cup point bolt has a depression at an end forming an outer edge that contacts the surface of the component.

16. The connector of claim 15, wherein the outer edge of the depression penetrates non-conductive coatings on the surface of the component.

17. The connector of claim 15, wherein the depression reduces an area of the cup point bolt in contact with the surface of the component which increases holding and locking power under pressure.

18. The connector of claim 11, wherein at least one of the arms extending from the body flexes providing a spring force that secures the penetrating fastener against the surface of the component.

19. A connector comprising:
a body made of an electrically conductive material;
a first slot formed in the body, the first slot dimensioned to receive an edge of a component;
a second slot formed in the body, the second slot dimensioned to receive a conductor; and
a penetrating fastener that can secure the edge of the component in the first slot and that can penetrate non-conductive coatings on a surface of the component to provide an electrically conductive path between the component and the body.

20. The connector of claim 19, wherein the fastener comprises a cup point bolt.

21. The connector of claim 20, wherein the cup point bolt has a depression at an end forming an outer edge that penetrates non-conductive coatings on the surface of the component.

22. The connector of claim 19, further comprising a first pair of arms extending from the body and forming the first slot.

23. The connector of claim 22, wherein the penetrating fastener comprises a bolt that extends through one of the first pair of arms.

24. The connector of claim 22, wherein at least one of the arms extending from the body flexes providing a spring force that secures the penetrating fastener against the surface of the component.

25. The connector of claim 22, further comprising a serrated surface formed on at least one of the first pair of arms, the serrated surface abutting the surface of the component.
